(19) United States
(12) Patent Application Publication
(10) Pub. No.: US 2020/0384858 A1
(43) Pub. Date: Dec. 10, 2020

(54) VEHICLE LEARN MODE INTERFACE

(71) Applicant: GM Global Technology Operations LLC, Detroit, MI (US)

(72) Inventors: Gregg Prottengeier, Plymouth, MI (US); Frederick Gersdorff, Harper Woods, MI (US); Christopher Hausner, Detroit, MI (US); Josh A. Cohen, Belleville, MI (US); Bradley A. Walker, Clarkston, MI (US); Terence E. Jackson, Farmington Hills, MI (US); Olugbenga O. Olumolade, Detroit, MI (US)

(21) Appl. No.: 16/434,826

(22) Filed: Jun. 7, 2019

(51) Int. Cl. B60K 35/00; B60W 50/14

(52) U.S. Cl. CPC B60K 35/00; B60W 50/14; B60W 2050/146; B60K 2370/157; B60K 2370/152; B60K 2370/161

(57) ABSTRACT

Embodiments include methods, systems and computer readable storage medium for a method for utilizing a vehicle learn mode is disclosed. The method includes receiving, by a learn mode user interface, a selection to use a vehicle learn mode. The method further includes receiving, by the learn mode user interface, a request for information about a user control or vehicle feature for a vehicle. The method further includes obtaining, by the learn mode user interface, the information from an electronic owner's manual for the vehicle. The method further includes outputting, by an audio system or a visual display, the information to a user.

### INTRODUCTION

The subject disclosure relates generally to features for vehicles and more particularly to providing information about vehicle features in a learning environment.

Vehicle systems have many different types of user controls such as buttons, knobs, sliders, touch screens, etc. that are used to control functions of the associated vehicle system. Owner's manuals typically provide printed instructions of the vehicle's systems and controls. While some user controls may be easy to understand, the function and use of other user controls may not be as readily apparent.

If a user does not know how to operate a system or control, there are a few ways to learn how the system or control works such as reading the owner's manual, but the user may fail to use the system or controls out of fear of damaging the vehicle or may attempt to operate the system or control by adjusting the control without instructions. If user operates the user system or control without instructions, the user may successfully use the system or control, but may not understand or may retain how it was achieved. If the user wants to operate the system or control again, there is a likelihood that the same “guessing game” will take place. In other instances, the user may attempt to look up the instructions in the owner's manual requiring the user to stop the vehicle in order to read the owner's manual.

Accordingly, it is be desirable to provide further improvements for learning the systems and features of a vehicle.

### SUMMARY

In one exemplary embodiment, a method for utilizing a vehicle learn mode is disclosed. The method includes receiving, by a learn mode user interface, a selection to use a vehicle learn mode. The learn mode user interface also receives a request for information about a user control or vehicle feature for a vehicle and obtains the information from an electronic owner's manual for the vehicle. An an audio system or a visual display outputs the information to a user.

In accordance with one or more embodiments or the method embodiment above, the method can comprise determining that the vehicle is operating safely.

In accordance with one or more embodiments or any of the method embodiments above, the method can comprise instructing the user to stop or park the vehicle to utilize the vehicle learn mode in response to determining that the vehicle is not operating safely.

In accordance with one or more embodiments or any of the method embodiments above, the method can comprise causing the learn mode user interface to enter the vehicle learn mode in response to determining that the vehicle is operating safely.

In accordance with one or more embodiments or any of the method embodiments above, the method can comprise disabling the vehicle learn mode in response to the vehicle not operating safely after entering the vehicle learn mode.

In accordance with one or more embodiments or any of the method embodiments above, the audio system or the visual display can be associated with the vehicle.

In accordance with one or more embodiments or any of the method embodiments above, the audio system or the visual display can be associated with a mobile device.

In one exemplary embodiment, a system for utilizing a vehicle learn mode is disclosed. The system includes a vehicle. The vehicle includes a memory, a processor coupled to the memory, a learn mode user interface, an audio system, and a visual display. The learn mode user interface is operable to receive a selection to use a vehicle learn mode and receive a request for information about a user control or vehicle feature for a vehicle. The learn mode user interface is also operable to obtain the information from an electronic owner's manual for the vehicle. The vehicle is operable to output the information to a user via the audio system or the visual display.

In accordance with one or more embodiments or the system embodiment above, the vehicle can be further operable to determine that the vehicle is operating safely.

In accordance with one or more embodiments or any of the system embodiments above, the learn mode user interface can be further operable to instruct the user to stop or park the vehicle to utilize the vehicle learn mode in response to determining that the vehicle is not operating safely.

In accordance with one or more embodiments or any of the system embodiments above, the learn mode user interface can be further operable to cause the learn mode user interface to enter the vehicle learn mode in response to determining that the vehicle is operating safely.

In accordance with one or more embodiments or any of the system embodiments above, the learn mode user interface can be further operable to disable the vehicle learn mode in response to the vehicle not operating safely after entering the vehicle learn mode.

In accordance with one or more embodiments or any of the system embodiments above, the information can be output to the user via a mobile device.

In one exemplary embodiment, a non-transitory computer readable medium having program instructions for utilizing a vehicle learn mode embodied therewith is disclosed. The program instructions are readable by a processor to cause the processor to receive a selection to use a vehicle learn mode and receive a request for information about a user control or vehicle feature for a vehicle. The program instructions are also readable by the processor to cause the processor to obtain the information from an electronic owner's manual for the vehicle and output the information to a user.

In accordance with one or more embodiments or the non-transitory computer readable medium embodiment above, the program instructions can be readable to cause the processor to determine that the vehicle is operating safely.

In accordance with one or more embodiments or any of the non-transitory computer readable medium embodiments above, the program instructions can be readable to cause the processor to instruct the user to stop or park the vehicle to utilize the vehicle learn mode in response to determining that the vehicle is not operating safely.

In accordance with one or more embodiments or any of the non-transitory computer readable medium embodiments above, the program instructions can be readable to cause the processor to cause the learn mode user interface to enter the vehicle learn mode in response to determining that the vehicle is not operating safely.

In accordance with one or more embodiments or any of the non-transitory computer readable medium embodiments above, the program instructions can be readable to cause the processor to disable the vehicle learn mode in response to the vehicle not operating safely after entering the vehicle learn mode.

In accordance with one or more embodiments or any of the computer readable medium embodiments above, the information can be output via an audio system or the visual display associated with the vehicle.

In accordance with one or more embodiments or any of the computer readable medium embodiments above, the information can be output via an audio system or the visual display associated with a mobile device.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram illustrating a communications system for practice of the teachings herein according to one or more embodiments; and

FIG. 2 depicts a flow diagram of a method for utilizing a vehicle learn mode according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

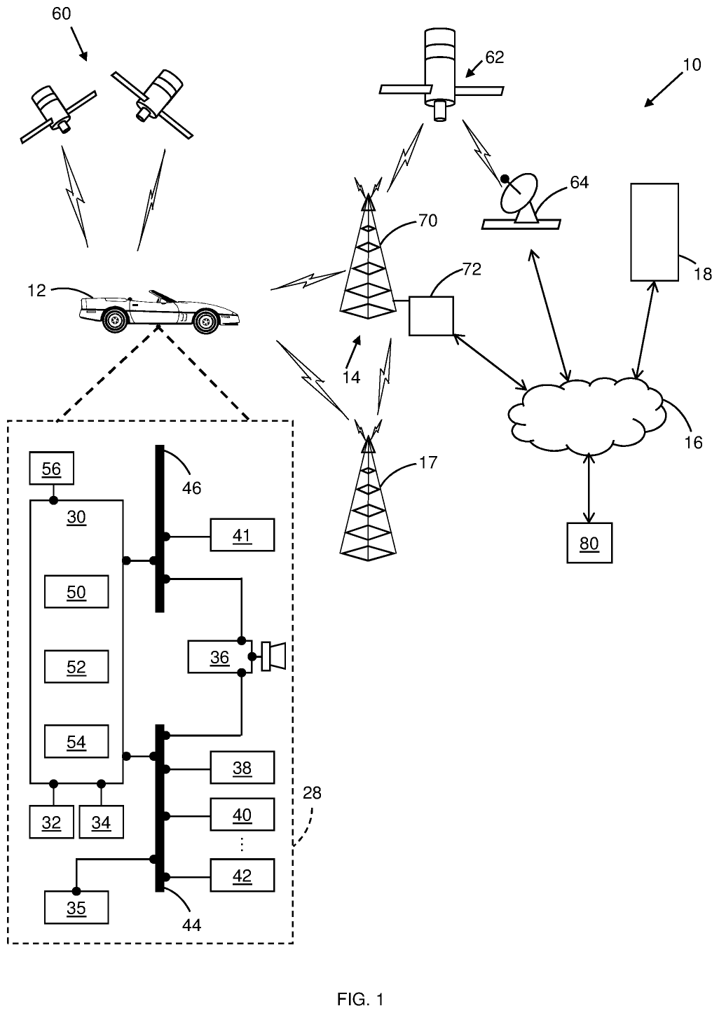

Referring now to FIG. 1, there is shown an operating environment that comprises a communications system 10. Communications system 10 generally includes a vehicle 12, one or more wireless carrier systems 14, a land communications network 16, a computer 18, and a remote facility 80. It should be understood that the disclosed method can be used with any number of different systems and is not specifically limited to the operating environment shown here.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, a learn mode user interface 35, an audio system 36, a visual display 38, and a GPS module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few. Vehicle electronics 28 can also include a transmission control module (TCM) (not shown). The TCM can signal an electronic transmission range selection (ETRS) system to shift a transmission of the vehicle 12 to a corresponding range in response to the control signal (e.g., park, reverse, low gear, drive, etc.).

Telematics unit 30 can be an OEM-installed (embedded) or aftermarket device that is installed in the vehicle and that enables wireless voice and/or data communication over wireless carrier system 14 and via wireless networking. This enables the vehicle to communicate with the remote facility 80, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle 12 to offer a number of different services including those related to navigation, telephony, emergency assistance, diagnostics, infotainment, etc. Data can be sent either via a data connection, such as via packet data transmission over a data channel, or via a voice channel.

The telematics unit 30 can utilize cellular communication according to either GSM or CDMA standards and thus includes a standard cellular chipset 50 for voice communications like hands-free calling, a wireless modem for data transmission, a processor 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as 4G LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally stored instructions, such as software or firmware programs stored in memory 54, which enable the telematics unit to provide a wide variety of services. For instance, processor 52 can execute programs or process data.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where audio broadcasts, webpages, movies, television programs, videogames and/or other information is downloaded by an infotainment module 41 and is stored for current or later playback. The infotainment module 41 can include a digital signal processor that receives terrestrial audio broadcasts from terrestrial antenna or can receive audio broadcasts from the wireless carrier system 14 as packetized data via the vehicle telematics unit 30 and entertainment bus 46. The infotainment module 41 and other elements of the vehicle 12, such as the microphone 32, the pushbuttons or control inputs 34, the learn mode user interface 35, the audio system 36, a visual display 38, and memory devices 54 can collectively be referred to as a center stack module (CSM). The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to the remote facility 80 or other remote computer system, such as computer 18, for other purposes, such as fleet management. In addition, new or updated map data can be downloaded to the GPS module 40 from the remote facility 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, learn mode user interface 35, audio system 36 and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice-processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating other vehicle functionality. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off the windshield, and can be used to provide a multitude of input and output functions.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, circuit-switched digital technologies such as CDMA (e.g., CDMA2000, EVDO, or HSPA+) or GSM/GPRS, as well as non-circuit switched/all IP based cellular standards (3GPP 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to the remote facility 80. For example, land network 16 may include a public switched telephone network (PSTN) such as that used to provide hardwired telephony, packet-switched data communications, and the Internet infrastructure. One or more segments of land network 16 could be implemented with a standard wired network, a fiber or other optical network, a cable network, power lines, other wireless networks such as wireless local area networks (WLANs), or networks providing broadband wireless access (BWA), or any combination thereof. Furthermore, the remote facility 80 need not be connected via land network 16, but could include wireless telephony equipment so that it can communicate directly with a wireless network, such as wireless carrier system 14. The land network 16 can also communicate with one or more terrestrial antennae 17 to supply digital radio broadcasts (DRBs) to the vehicle 12. A central facility, such as a computer 18 (discussed herein) or a radio station (not shown), can generate the DRBs as packetized data and transmit the data to the antenna 17 where it can be converted to a digital audio signal and locally broadcast. When the vehicle 12 is within range of the broadcast signal, the vehicle 12 can receive the signal via the antenna 56 and pass the signal to the infotainment module 41 via the entertainment bus 46. Examples of how the DRBs are transmitted or received include in-band on-channel radio (IBOC), such as NRSC-5 or NRSC-5-C. IBOC can include digital radio systems such as HD Radio™, FMeXtra, Digital Audio Broadcasting (DAB), Digital Radio Mondiale (DRM30 and DRM+ configurations), and Compatible AM-Digital (CAM-D), to name a few. DRBs can also include Internet radio provided by packet data over the cellular network.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30 or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 may be designed to provide the vehicle electronics 28 with a number of different system back-end functions. The remote facility 80 may include one or more switches, servers and databases. Remote facility 80 may receive and transmit data via a modem connected to land network 16. A database at the remote facility 80 can store account information, vehicle identifiers, electronic versions of vehicle owner's manuals and user profile records. Data transmissions may also be conducted by wireless systems, such as IEEE 802.11x, GPRS, and the like. The remote facility 80 or computers 18 can include numerous servers and databases that can be used in conjunction with one or more embodiments discussed herein. In such embodiments, the remote facility 80 or computer 18 can store vehicle information in one or more databases (or memory devices) and can communicate with each of the vehicles 12.

The learn mode user interface 35 can be an interface in which a user can input a request for information about user controls such as buttons, knobs, sliders, symbols, touch screens and/or vehicle features (e.g., traction control, cruise control, launch control, etc.). When interacting with the vehicle 12, the user can activate a learn mode for the vehicle 12 via the learn mode user interface 35. While in the learn mode, the user can press a user control or vehicle feature or provide a voice request (voice command) for information about the user control or vehicle feature. The learn mode user interface 35 can access an electronic owner's manual for vehicle 12 that is stored in the learn mode user interface 35 or the remote facility 80 to obtain information about the requested user control or vehicle feature. The learn mode user interface 35 can use other components of the vehicle electronics 28 to provide the requested information to the user (stored in the learn mode user interface 35 or transmitted from the remote facility 80) via the audio system 36 and/or the visual display 38. Accordingly, the learn mode user interface 35 can be used to provide an explanation of user controls and vehicle features to users upon request, (i.e., what the user control or vehicle feature does and/or when to use the user control or vehicle feature). The learn mode user interface 35 can also be accessed via an application on a mobile phone.

The learn mode user interface 35 can be accessed under safe vehicle conditions/operation (e.g., while the vehicle is stopped and/or parked). The processor 52 can determine whether the learn mode user interface 35 can be used by deciding if the vehicle is operating safely using transmission information obtained from the TCM. If the vehicle is not operating safely (i.e., the vehicle is moving) the vehicle electronics 28 can instruct the user via the audio system 36 and/or the visual display 38 to stop the vehicle in order to obtain vehicle information about a desired user control or vehicle feature via the learn mode user interface 35.

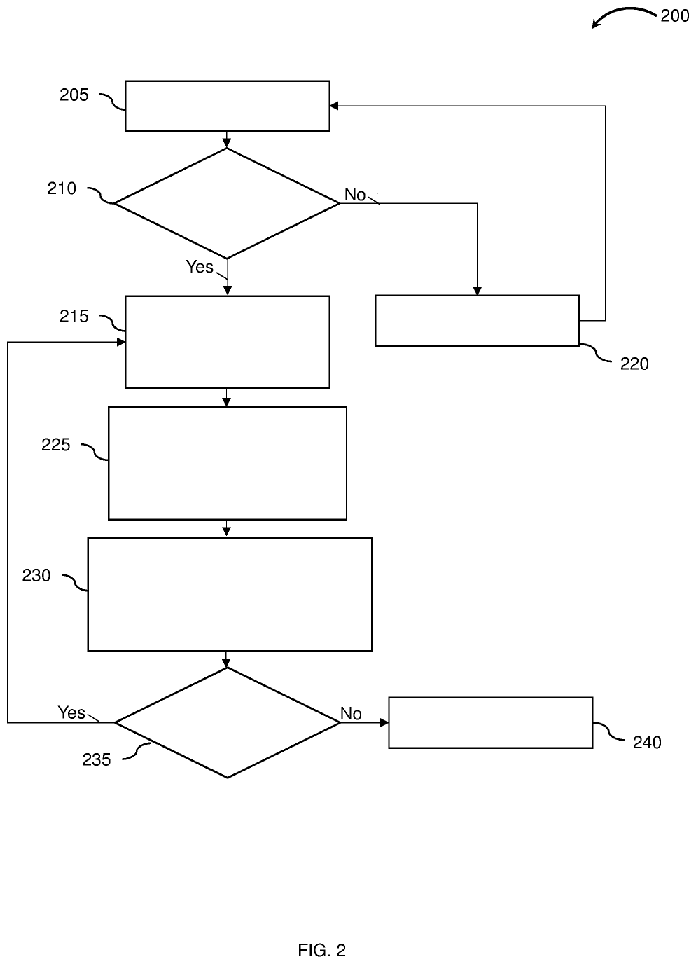

FIG. 2 depicts a flow diagram of a method 200 for utilizing a vehicle learn mode according to one or more embodiments. At block 205, a vehicle can receive a selection to use a vehicle learn mode, via a learn mode user interface. At block 210, the vehicle can use a processor and transmission information provided by the transmission control module (TCM) to determine whether the vehicle is operating safely (e.g., the vehicle is stopped and/or parked). If the vehicle is not operating safely, the method 200 proceeds to block 220 where the vehicle instructs a user to stop and/or park the vehicle to use the vehicle learn mode. After block 220, the method 200 returns to block 205.

If the vehicle is operating safely, the method 200 proceeds to block 215 where the vehicle can receive a selection of a user control or a vehicle feature in which more information is desired by the user via the learn mode user interface. At block 225, the vehicle can obtain information about the requested user control or vehicle feature from an electronic owner's manual for the vehicle. The electronic owner's manual can be stored at the vehicle or at a remote facility. At block 230, the vehicle can provide the obtained information about the requested user control or vehicle feature to the user via an audio system and/or the visual display of the vehicle. At block 235, the vehicle, while in a vehicle learn mode, can use the processor and transmission information provided by the TCM to determine whether the vehicle is still operating safely (i.e., is the user still using the vehicle learn mode or is the user operating the vehicle (vehicle moving?)). If the vehicle is still operating safely, the method 200 returns to block 215. If the vehicle is not operating safely, the method 200 proceeds to block 240 where the vehicle disables the vehicle learn mode.

Accordingly, the embodiments disclosed herein describe a system that can teach customers about features, functions and symbols of their vehicle. The system includes a “learn mode” that can be accessed using a learn mode user interface that allows the user to interact with instrument panel features, buttons and symbols. By selecting or depressing a button or symbol while in the vehicle learn mode, the vehicle can provide an explanation of the instrument panel features, buttons and symbols using audio and/or visual devices of the vehicle or a mobile phone associated with the user.

Technical effects and benefits of the disclosed embodiments include, but are not limited to mitigating user frustration about user controls and vehicle features of a vehicle. The disclosed system improves user experience with a vehicle by providing information about user controls and vehicle features in an interactive manner thereby allowing the user to fully understand and utilize their vehicle.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other devices to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for utilizing a vehicle learn mode, the method comprising:
receiving, by a learn mode user interface, a selection to use a vehicle learn mode;
receiving, by the learn mode user interface, a request for information about a user control or vehicle feature for a vehicle;
obtaining, by the learn mode user interface, the information from an electronic owner's manual for the vehicle; and
outputting, by an audio system or a visual display, the information to a user.

2. The method of claim 1, further comprising determining that the vehicle is operating safely.

3. The method of claim 2, further comprising instructing the user to stop or park the vehicle to utilize the vehicle learn mode in response to determining that the vehicle is not operating safely.

4. The method of claim 2, further comprising causing the learn mode user interface to enter the vehicle learn mode in response to determining that the vehicle is operating safely.

5. The method of claim 3, further comprising disabling the vehicle learn mode in response to the vehicle not operating safely after entering the vehicle learn mode.

6. The method of claim 1, wherein the audio system or the visual display are associated with the vehicle.

7. The method of claim 1, wherein the audio system or the visual display are associated with a mobile device.

8. A system for utilizing a vehicle learn mode, the system comprising:
a vehicle comprising:
a memory and a processor coupled to the memory;
a learn mode user interface;
an audio system; and
a visual display,
wherein the learn mode user interface is operable to:
receive a selection to use a vehicle learn mode;
receive a request for information about a user control or vehicle feature for a vehicle; and
obtain the information from an electronic owner's manual for the vehicle, and
wherein the vehicle is operable to output the information to a user via the audio system or the visual display.

9. The system of claim 8, wherein the vehicle is further operable to determine that the vehicle is operating safely.

10. The system of claim 9, wherein the learn mode user interface is further operable to instruct the user to stop or park the vehicle to utilize the vehicle learn mode in response to determining that the vehicle is not operating safely.

11. The system of claim 9, wherein the learn mode user interface is further operable to cause the learn mode user interface to enter the vehicle learn mode in response to determining that the vehicle is operating safely.

12. The system of claim 11, wherein the learn mode user interface is further operable to disable the vehicle learn mode in response to the vehicle not operating safely after entering the vehicle learn mode.

13. The system of claim 8, wherein the information is output to the user via a mobile device.

14. A non-transitory computer readable medium having program instructions utilizing a vehicle learn mode embodied therewith, the program instructions readable by a processor to cause the processor to:
receive a selection to use a vehicle learn mode;
receive a request for information about a user control or vehicle feature for a vehicle;
obtain the information from an electronic owner's manual for the vehicle; and
output the information to a user.

15. The computer readable medium of claim 14, the program instructions readable by a processor to cause the processor to determine that the vehicle is operating safely.

16. The computer readable medium of claim 15, the program instructions readable by a processor to cause the processor to instruct the user to stop or park the vehicle to utilize the vehicle learn mode in response to determining that the vehicle is not operating safely.

17. The computer readable medium of claim 15, the program instructions readable by a processor to cause the processor to cause the learn mode user interface to enter the vehicle learn mode in response to determining that the vehicle is not operating safely.

18. The computer readable medium of claim 17, the program instructions readable by a processor to cause the processor to disable the vehicle learn mode in response to the vehicle not operating safely after entering the vehicle learn mode.

19. The computer readable medium of claim 14, wherein the information is output via an audio system or the visual display associated with the vehicle.

20. The computer readable medium of claim 14, wherein the information is output via an audio system or the visual display associated with a mobile device.
